(19) United States
(12) Patent Application Publication
(10) Pub. No.: US 2012/0165460 A1
(43) Pub. Date: Jun. 28, 2012

(54) Polycarbonate Resin Composition Having Good Mold Release Properties and Good Appearance and Molded Article Using the Same

(75) Inventors: Hwan Seok PARK, Uiwang-si (KR); Jin Seong LEE, Uiwang-si (KR); Jong Tae YOON, Uiwang-si (KR); Yun Ku NAM, Uiwang-si (KR); Min Jung KANG, Uiwang-si (KR); Seung Shik SHIN, Uiwang-si (KR); Woo Jung KIM, Uiwang-si (KR); Kyuong Sik CHIN, Uiwang-si (KR)

(73) Assignee: CHEIL INDUSTRIES INC., Gumi-si (KR)

(21) Appl. No.: 13/239,840

(22) Filed: Sep. 22, 2011

(30) Foreign Application Priority Data
Dec. 28, 2010 (KR) 10-2010-0137105

(51) Int. Cl. C08L 83/04; C08L 83/10

(52) U.S. Cl. 524/537; 525/431; 525/439; 525/101

(57) ABSTRACT

The present invention discloses a polycarbonate resin composition which includes a polycarbonate resin (A), a polycarbonate-polysiloxane copolymer (B), and a siloxane copolyester (C), wherein the siloxane copolyester (C) is present in an amount of about 0.1 to about 6 wt % based on 100 wt % of a base resin including the polycarbonate resin (A), polycarbonate-polysiloxane copolymer (B), and siloxane copolyester (C). The composition can have excellent mold release properties and appearance.

### CROSS-REFERENCE TO RELATED APPLICATIONS

This application claims priority under 35 USC Section 119 from Korean Patent Application No. 10-2010-0137105, filed Dec. 28, 2010, the entire disclosure of which is incorporated herein by reference.

### FIELD OF THE INVENTION

The present invention relates to a polycarbonate resin composition that can have good mold release properties and good appearance and a molded article made using the same.

### BACKGROUND OF THE INVENTION

In polycarbonate/acrylonitrile-butadiene-styrene (PC/ABS) alloys, polycarbonate generally improves impact strength and heat resistance, and ABS enhances processibility and chemical resistance. Thus, PC/ABS alloys can be used in various applications due to their excellent physical properties as compared with ABS and cost efficiency as compared with polycarbonate. For example, resins used in the production of housings for electronic goods are required to have flame retardancy and excellent injection molding efficiency. Further, resins should be readily injection-molded in molds with complicated shapes to provide products having various shapes.

Recently, polycarbonate-polydimethylsiloxane (PDMS) copolymers have been used to provide excellent physical properties and workability as compared with polycarbonate.

Generally, one method of improving injection mold release property of resins is to use various kinds of release agents. Such release agents can be classified as organic compounds or silicon oils.

Representative organic compound release agents may include stearamide, oleamide, and the like. However, it can be difficult to provide adequate release properties using these organic compound release agents because such compounds can decrease physical properties and deposition in a mold, particularly with larger amounts of the release agent. This can be particularly problematic when molding PC/ABS due to high process temperatures used in the same.

Korean Patent Publication No. 2010-0040946 discloses an organic compound release agent. However, when an insufficient amount of this release agent is used, desired mold release properties cannot be secured. When the amount of release agent is excessive, however, physical properties are deteriorated.

A representative silicone oil release agent is PDMS, which can provide excellent mold release properties even in small amounts. However, PDMS can be deposited in a mold due to poor compatibility with a resin and can generate a pearl mark due to the difference in the refractive index of PDMS and the resin.

Korean Patent Publication No. 2003-0060973 discloses a method employing silicone oil including a phenyl group. The silicone oil can provide an excellent appearance (with respect to pearl marks) but also can exhibit relatively reduced mold release properties as compared with PDMS.

Therefore, there is a need to develop a material having excellent mold release properties, appearance and spiral flow, with minimal or no decrease in physical properties, and exhibiting superior flame retardancy.

### SUMMARY OF THE INVENTION

The present invention provides a polycarbonate resin composition that can have excellent mold release properties and appearance, can exhibit excellent spiral flow while maintaining transparency, and can have a superior balance of properties such as flame retardancy, impact resistance, mold release properties, heat resistance, and appearance.

In one embodiment, the present invention provides a polycarbonate resin composition that can have excellent mold release properties and appearance. The polycarbonate resin composition includes a polycarbonate resin (A), a polycarbonate-polysiloxane copolymer (B), and a siloxane copolyester (C), wherein the siloxane copolyester (C) is present in an amount of about 0.1 to about 6 wt % based on the total weight of the composition, based on 100 wt % of a base resin including the polycarbonate resin (A), polycarbonate-polysiloxane copolymer (B), and siloxane copolyester (C).

The polycarbonate-polysiloxane copolymer (B) may include about 1 to about 99 wt % of the polycarbonate block and about 1 to about 99 wt % of the polysiloxane block.

The siloxane copolyester (C) may have a number average molecular weight (Mn) of about 5,500 to about 7,500 g/mol.

The siloxane copolyester (C) may be an ABA type block copolymer of a polyester block and a polysiloxane block. The siloxane copolyester (C) may include about 30 to about 70 wt % of the polyester block and about 30 to about 70 wt % of the polysiloxane block, and the polyester may have a number average molecular weight of about 1,000 to about 3,000 g/mol.

The siloxane copolyester (C) may include a repeat unit represented by Formula 1:

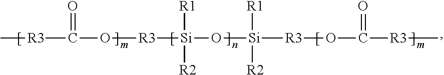

wherein:

R1 and R2 are the same or different and are independently substituted or unsubstituted C1 to C20 alkyl, substituted or unsubstituted C2 to C20 alkenyl, substituted or unsubstituted C2 to C20 alkynyl, substituted or unsubstituted C1 to C20 alkoxy, is substituted or unsubstituted C3 to C30 cycloalkyl, substituted or unsubstituted C3 to C30 cycloalkenyl, substituted or unsubstituted C3 to C30 cycloalkynyl, substituted or unsubstituted C6 to C30 aryl, substituted or unsubstituted C6 to C30 aryloxy, or NRR′, wherein R and R′ are the same or different and are independently hydrogen or substituted or unsubstituted C1 to C20 alkyl;

R3 is C1 to C10 alkylene or C6 to C20 arylene:

n is an integer from 5 to 50; and

m is an integer from 5 to 30.

The composition may include about 40 to about 85 wt % of the polycarbonate resin (A), about 10 to about 55 wt % of the polycarbonate-polysiloxane copolymer (B), and about 0.1 to about 6 wt % of the siloxane copolyester (C), based on 100 wt % of a base resin including the polycarbonate resin (A), polycarbonate-polysiloxane copolymer (B), and siloxane copolyester (C).

The composition may further include an impact reinforcing agent.

The composition may further include a flame retardant.

The resin composition may further include at least one additive selected from the group consisting of impact reinforcing agents, flame retardants, anti-dripping agents, antimicrobials, heat stabilizers, antioxidants, release agents, photo-stabilizers, inorganic additives, surfactants, coupling agents, plasticizers, admixtures, stabilizers, lubricants, anti-static agents, toning agents, fire proofing agents, weather proofing agents, coloring agents, UV absorbents, UV blocking agents, fillers, nucleating agents, adhesion aids, adhesives, and combinations thereof.

The polycarbonate resin composition may have a UL94 flammability rating of about VO or more, measured on an about 1 mm-thick specimen, and an impact strength of to about 35 kgfcm/cm or more, measured on a ⅛″-thick specimen by ASTM D1925.

The present invention also provides a molded article made using the polycarbonate resin composition.

### BRIEF DESCRIPTION OF THE DRAWINGS

FIGS. 1(a) and (b) are photographs illustrating the best mold release properties and the worst mold release properties, respectively, when a grille mold is used according to the examples and comparative examples; and

FIGS. 2(a) and (b) are photographs illustrating the best appearance and the worst appearance, respectively, with respect to the extent to which pearl marks occur on a welded part according to the examples and comparative examples.

### DETAILED DESCRIPTION OF THE INVENTION

The present invention now will be described more fully hereinafter in the following detailed description of the invention with reference to the accompanying drawings, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, unless a specific definition is otherwise provided, the term “substituted” means that a hydrogen atom of a compound is substituted with halogen, such as F, Cl, Br, or I, hydroxyl, nitro, cyano, amino, azido, amidino, hydrazino, hydrazono, carbonyl, carbamyl, thiol, ester, carboxyl or salt thereof, sulfonic acid or salt thereof, phosphate or salt thereof, C1 to C20 alkyl, C2 to C20 alkenyl, C2 to C20 alkynyl, C1 to C20 alkoxy, C6 to C30 aryl, C6 to C30 aryloxy, C3 to C30 cycloalkyl, C3 to C30 cycloalkenyl, C3 to C30 cycloalkynyl, or a combination thereof.

A polycarbonate resin composition according to exemplary embodiments of the present invention includes a polycarbonate resin (A), a polycarbonate-polysiloxane copolymer (B), and a siloxane copolyester (C).

Hereinafter, each component will be described in detail.

(A) Polycarbonate Resin

The polycarbonate resin may be prepared by reaction of one or more diphenols represented by Formula 2 with phosgene, halogen acid ester, carbonic acid ester, or a combination thereof:

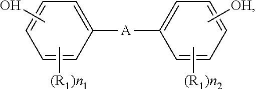

wherein:

A is a single bond, substituted or unsubstituted linear or branched C1 to C30 alkylene, substituted or unsubstituted C2 to C5 alkenylene, substituted or unsubstituted C2 to C5 alkylidene, substituted or unsubstituted linear or branched C1 to C30 haloalkylene, substituted or unsubstituted C5 to C6 cycloalkylene, substituted or unsubstituted C5 to C6 cycloalkenylene, substituted or unsubstituted C5 to C10 cycloalkylidene, substituted or unsubstituted C6 to C30 arylene, substituted or unsubstituted C1 to C20 linear or branched alkoxylene, halogen acid ester, carbonic acid ester, CO, S, or SO₂;

R₁ and R₂ are the same or different and are independently substituted or unsubstituted C1 to C30 alkyl or substituted or unsubstituted C6 to C30 aryl; and

n₁ and n₂ each are an integer from 0 to 4.

The polycarbonate resin may have a repeat unit obtained by combining at least two kinds of the diphenols represented by Formula 2. Examples of the diphenols may include without limitation hydroquinone, resorcinol, 4,4′-dihydroxy diphenyl, 2,2-bis(4-hydroxyphenyl)propane (bisphenol-A), 2,4-bis(4-hydroxyphenyl)-2-methylbutane, bis(4-hydroxyphenyl)methane, 1,1-bis(4-hydroxyphenyl)cyclohexane, 2,2-bis(3-chloro-4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, bis(4-hydroxyphenyl)sulfoxide, bis(4-hydroxyphenyl)ketone, bis(4-hydroxyphenyl)ether, and the like, and combinations thereof. In exemplary embodiments, 2,2-bis(4-hydroxyphenyl)propane, 2,2-bis(3-chloro-4-hydroxyphenyl)propane, and/or 1,1-bis(4-hydroxyphenyl)cyclohexane may be used.

The polycarbonate resin may have a weight average molecular weight of about 10,000 to about 200,000 g/mol. In one embodiment, the polycarbonate resin may have a weight average molecular weight of about 15,000 to about 80,000 g/mol, without being limited thereto.

The polycarbonate resin may be a mixture of copolymers prepared from at least two kinds of diphenols. Further, the polycarbonate resin may include a linear polycarbonate resin, a branched polycarbonate resin, a polyester-carbonate copolymer resin, or a combination thereof.

Examples of the linear polycarbonate resin may include bisphenol-A polycarbonate resins. Examples of the branched polycarbonate resin may include compounds prepared by reaction of a multifunctional aromatic compound, such as trimellitic anhydride and trimellitic acid, with diphenols and carbonate. The multifunctional aromatic compound may be present in an amount of about 0.05 to about 2 mol % based on the total amount of the branched polycarbonate resin. Examples of the polyester-carbonate copolymer resin may include compounds prepared by reaction of a bifunctional carboxylic acid with diphenols and carbonate. Examples of the carbonate may include diaryl carbonate, such as diphenyl carbonate, and ethylene carbonate.

The polycarbonate resin may have a melt index (MI) of about 3 to about 120 g/10 min at about 300° C. and about 1.2 kgf, for example about 10 to about 60 g/10 min. Within this range, excellent mechanical properties and injection fluidity can be obtained. In one embodiment, the polycarbonate resin may have an MI of about 12 to about 55 g/10 min, for example about 15 to about 35 g/10 min.

The polycarbonate resin composition may include the polycarbonate resin in an amount of about 40 to about 85 wt %, for example about 45 to about 80 wt %, and as another example about 50 to about 75 wt %, based on 100 wt % of a base resin including the polycarbonate resin (A), polycarbonate-polysiloxane copolymer (B), and siloxane copolyester (C). In some embodiments, the polycarbonate resin composition may include the polycarbonate resin (A) in an amount of about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, or 85 wt %. Further, according to some embodiments of the present invention, the amount of the polycarbonate resin (A) can be in a range from about any of the foregoing amounts to about any other of the foregoing amounts.

When the polycarbonate resin composition includes the polycarbonate resin in an amount within this range, the composition may exhibit an excellent balance of properties such as impact strength, heat resistance, and processibility.

(B) Polycarbonate-Polysiloxane Copolymer

The polycarbonate-polysiloxane copolymer includes a polycarbonate block and a polysiloxane block.

The polycarbonate block may include a structural unit derived from the polycarbonate resin (A).

The polysiloxane block may include a structural unit represented by Formula 3:

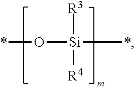

wherein:

R³ and R⁴ may be the same or different and are independently hydrogen, substituted or unsubstituted C1 to C20 alkyl, substituted or unsubstituted C2 to C20 alkenyl, substituted or unsubstituted C2 to C20 alkynyl, substituted or unsubstituted C1 to C20 alkoxy, substituted or unsubstituted C3 to C30 cycloalkyl, substituted or unsubstituted C3 to C30 cycloalkenyl, substituted or unsubstituted C3 to C30 cycloalkynyl, substituted or unsubstituted C6 to C30 aryl, substituted or unsubstituted C6 to C30 aryloxy, or NRR′, wherein R and R′ are the same or different and are independently hydrogen or substituted or unsubstituted C1 to C20 alkyl, and

2≦m<10,000.

In Formula 3, m may be in the range from about 2 to about 10,000. In one embodiment, m may be in the range from about 2 to about 1,000. In other exemplary embodiments, m may be about 10 to about 100, for example about 25 to about 80. When m is within this range, excellent impact resistance can be obtained and proper viscosity can be maintained, providing favorable conditions for extrusion.

The polycarbonate-polysiloxane copolymer may include about 1 to about 99 wt % of the polycarbonate block and about 1 to about 99 wt % of the polysiloxane block. In one embodiment, the polycarbonate-polysiloxane copolymer may include about 40 to about 80 wt % of the polycarbonate block and about 20 to about 60 wt % of the polysiloxane block. In another embodiment, the polycarbonate-polysiloxane copolymer may include about 80 to about 95 wt % of the polycarbonate block and about 5 to about 20 wt % of the polysiloxane block.

In some embodiments, the polycarbonate-polysiloxane copolymer may include the polycarbonate block in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the polycarbonate block can be in a range from about any of the foregoing amounts to about any other of the foregoing amounts.

In some embodiments, the polycarbonate-polysiloxane copolymer may include the polysiloxane block in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the polysiloxane block can be in a range from about any of the foregoing amounts to about any other of the foregoing amounts.

When the polycarbonate-polysiloxane copolymer includes polycarbonate block and the polysiloxane block in amounts within these ranges, excellent impact resistance can be obtained.

The polycarbonate-polysiloxane copolymer may have a weight average molecular weight of about 10,000 to about 30,000 g/mol, for example about 15,000 to about 22,000 g/mol. Within this range, excellent impact resistance can be obtained.

The polycarbonate-polysiloxane copolymer may have an MI of about 3 to about 100 g/10 min at about 300° C. and about 1.2 kgf, for example about 10 to about 70 g/10 min. Within this range, excellent mechanical properties and injection fluidity can be obtained. In exemplary embodiments, the polycarbonate-polysiloxane copolymer (B) may have a higher MI than the polycarbonate resin (A).

The polycarbonate resin composition may include the polycarbonate-polysiloxane copolymer (B) in an amount of about 10 to about 55 wt %, for example about 15 to about 50 wt %, and as another example about 20 to about 45 wt %, based on 100 wt % of the base resin including the polycarbonate resin (A), polycarbonate-polysiloxane copolymer (B), and siloxane copolyester (C). In some embodiments, the polycarbonate resin composition may include the polycarbonate-polysiloxane copolymer (B) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55 wt %. Further, according to some embodiments of the present invention, the amount of the polycarbonate-polysiloxane copolymer (B) can be in a range from about any of the foregoing amounts to about any other of the foregoing amounts.

When the polycarbonate resin composition includes the polycarbonate-polysiloxane copolymer (B) in an amount within this range, the composition may exhibit an excellent balance of properties such as impact strength, heat resistance, and processibility.

(C) Siloxane Copolyester

The siloxane copolyester can improve mold release properties and appearance. When the siloxane copolyester is used together with the polycarbonate-polysiloxane copolymer (B), desired effects can be obtained.

The siloxane copolyester may have a number average molecular weight of about 5,500 to about 7,500 g/mol, for example 6,000 to about 7,000 g/mol. Further, the polyester of the siloxane copolyester may have a number average molecular weight of about 1,000 to about 3,000 g/mol, for example about 1,500 to about 2,500 g/mol. Within this range, fluidity and mold release properties can be improved while maintaining excellent compatibility and mechanical properties.

The siloxane copolyester (C) may be an ABA type block copolymer of a polyester block and a polysiloxane block. In one embodiment, the siloxane copolyester (C) may include about 30 to about 70 wt % of the polyester block and about 30 to about 70 wt % of the polysiloxane block.

In some embodiments, the siloxane copolyester (C) may include the polyester block in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the polyester block can be in a range from about any of the foregoing amounts to about any other of the foregoing amounts.

In some embodiments, the siloxane copolyester (C) may include the polysiloxane block in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the polysiloxane block can be in a range from about any of the foregoing amounts to about any other of the foregoing amounts.

When the siloxane copolyester (C) includes polyester block and polysiloxane block in amounts within these ranges, excellent fluidity, mold release properties, and property balance can be obtained.

In one embodiment, the siloxane copolyester (C) may include a repeat unit represented by Formula 1:

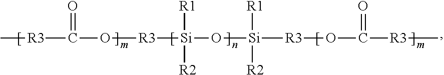

wherein:

R1 and R2 are the same or different and are independently substituted or unsubstituted C1 to C20 alkyl, substituted or unsubstituted C2 to C20 alkenyl, substituted or unsubstituted C2 to C20 alkynyl, substituted or unsubstituted C1 to C20 alkoxy, substituted or unsubstituted C3 to C30 cycloalkyl, substituted or unsubstituted C3 to C30 cycloalkenyl, substituted or unsubstituted C3 to C30 cycloalkynyl, substituted or unsubstituted C6 to C30 aryl, substituted or unsubstituted C6 to C30 aryloxy, or NRR′, wherein R and R′ are the same or different and are independently hydrogen or substituted or unsubstituted C1 to C20 alkyl;

R3 is C1 to C10 alkylene or C6 to C20 arylene;

n is an integer from 5 to 50; and

m is an integer from 5 to 30.

In one embodiment, the siloxane copolyester (C) may be prepared by polymerization of siloxane and caprolactam.

Alternatively, the siloxane copolyester (C) may be prepared by polymerization of siloxane, diol, and dicarboxylic acid.

The polycarbonate resin composition may include the siloxane copolyester (C) in an amount of about 0.1 to about 6 wt %, for example about 0.1 to about 5 wt %, based on 100 wt % of the base resin including the polycarbonate resin (A), polycarbonate-polysiloxane copolymer (B), and siloxane copolyester (C). In some embodiments, the polycarbonate resin composition may include the siloxane copolyester (C) in an amount of about 0.1, 0.2, 0.3, 0.4, 0.5, 0.6, 0.7, 0.8, 0.9, 1, 2, 3, 4, 5, or 6 wt %. Further, according to some embodiments of the present invention, the amount of the siloxane copolyester (C) can be in a range from about any of the foregoing amounts to about any other of the foregoing amounts.

When the polycarbonate resin composition includes the siloxane copolyester (C) in an amount less than about 0.1 wt %, mold release properties and appearance can be deteriorated. When the polycarbonate resin composition includes the siloxane copolyester (C) in an amount more than about 6 wt %, flame retardancy and impact strength can be deteriorated.

The polycarbonate resin composition may further include an impact reinforcing agent to improve impact resistance.

In one embodiment, the impact reinforcing agent may have a core-shell structure.

The impact reinforcing agent may be a rubber-modified graft copolymer or an olefin copolymer.

The rubber-modified graft copolymer may be prepared by graft-polymerization of a rubber polymer with a graft-copolymerizable monomer, and rubber of the rubber-modified graft copolymer may be present in an amount of about 20 to about 80 wt %. Examples of the rubber polymer may include without limitation diene rubbers, acrylate rubbers, silicone rubbers, and the like, combinations thereof. Examples of the diene rubber may include without limitation butadiene, isoprene, and the like, and combinations thereof. Examples of the acrylate rubber may include without limitation monomers, such as methyl acrylate, ethyl acrylate, n-propyl acrylate, n-butyl acrylate, 2-ethylhexyl acrylate, hexyl acrylate, 2-ethylhexyl methacrylate, and the like, and combinations thereof. The silicone rubber may be prepared from cyclosiloxanes. Examples of the cyclosiloxanes may include without limitation hexamethyl cyclotrisiloxane, octamethyl cyclotetrasiloxane, decamethyl cyclopentasiloxane, dodecamethyl cyclohexasiloxane, trimethyltriphenyl cyclotrisiloxane, tetramethyltetraphenyl cyclotetrasiloxane, octaphenyl cyclotetrasiloxane, and the like, and combinations thereof. In addition, polyolefin rubbers, such as ethylene/propylene rubber and ethylene-propylene-diene terpolymer (EPDM), may be used.

The rubber may have a diameter of about 50 to about 500 nm, for example about 75 to about 350 nm. Within this range, a balance of transparency and impact strength of the resin can be maintained.

Examples of the monomer graft-copolymerizable with the rubber polymer may include, without being limited to, styrene monomers, such as styrene, α-methylstyrene, and C1-C10 alkyl-substituted styrene; nitrile monomers, such as acrylonitrile and methacrylonitrile; (meth)acrylate monomers, such as methyl methacrylate and methyl acrylate; acid anhydrides, such as maleic anhydride; C1-C10 alkyl or phenyl nucleus substituted maleimide, and the like, which may be used alone or in combination.

The polycarbonate resin composition may include the impact reinforcing agent in an amount of about 15 wt % or less, for example about 0.5 to about 10 wt %, and as another example about 1 to about 7 wt %, based on the total weight of the resin composition. In some embodiments, the polycarbonate resin composition may include the impact reinforcing agent in an amount of about 0.5, 0.6, 0.7, 0.8, 0.9, 1, 2, 3, 4, 5, 6, 7, 8, 9, 10, 11, 12, 13, 14, or 15 wt %. Further, according to some embodiments of the present invention, the amount of the impact reinforcing agent can be in a range from about any of the foregoing amounts to about any other of the foregoing amounts.

The resin composition may further include a flame retardant to improve flame retardancy. Exemplary flame retardant may include without limitation phosphorus flame retardants, halogenated flame retardants, and the like, and combinations thereof.

The phosphorus flame retardants refer to flame retardants containing phosphorus generally used in the art and can include without limitation red phosphorus, phosphates, phosphonates, phosphinates, phosphine oxides, phosphazenes, metal salts thereof, and the like, and combinations thereof.

The halogenated flame retardants may include any halogen compound functioning as a flame retardant. Examples of the halogenated flame retardants may include without limitation commercially available halogenated flame retardants, such as decabromodiphenyl ether, decabromodiphenyl ethane, tetrabromobisphenol-A, tetrabromobisphenol-A epoxy oligomers, octabromotrimethylphenyl indane, ethylene-bis(tetrabrotnophthalimide), tris(tribromophenol)triazine, brominated polystyrene, and the like, and combinations thereof. In exemplary embodiments, the halogenated flame retardants may include halogen compounds melted at conventional process temperatures, such as halogen compounds having a melting point or softening point of about 250° C. or less.

The polycarbonate resin composition may include the flame retardant in an amount of about 20 wt % or less, for example about 1 to about 15 wt %, based on the total weight of the resin composition. In some embodiments, the polycarbonate resin composition may include the flame retardant in an amount of about 1, 2, 3, 4, 5, 6, 7, 8, 9, 10, 11, 12, 13, 14, 15, 16, 17, 18, 19, or 20 wt %. Further, according to some embodiments of the present invention, the amount of the flame retardant can be in a range from about any of the foregoing amounts to about any other of the foregoing amounts.

When the polycarbonate resin composition includes flame retardant in an amount within this range, the composition can have an excellent balance of flame retardancy and impact strength.

The polycarbonate resin composition may further include at least one additive selected from the group consisting of impact reinforcing agents, flame retardants, anti-dripping agents, antimicrobial agents, heat stabilizers, antioxidants, release agents, photo-stabilizers, inorganic additives, surfactants, coupling agents, plasticizers, admixtures, stabilizers, lubricants, anti-static agents, toning agents, fireproofing agents, weatherproofing agents, coloring agents, UV absorbents, UV blocking agents, fillers, nucleating agents, adhesion aids, adhesives, and the like, and combinations thereof.

An example of the anti-dripping agent may include without limitation polytetrafluoroethylene (PTFE), such as polytetrafluoroethylene capsulated with an aromatic vinyl resin. The polycarbonate resin composition can include the anti-dripping agent in an amount of 1.5 wt % or less, for example about 1 wt % or less, and as another example about 0.8 wt % or less, based on the total weight of the composition. When the polycarbonate resin composition includes an anti-dripping agent in an amount within this range, the composition can exhibit a balance between transparency and anti-dripping properties.

Examples of the antioxidants may include without limitation phenol antioxidants, phosphite antioxidants, thioether antioxidants, amine antioxidants, and the like, and combinations thereof.

Examples of the release agents may include without limitation fluorine containing polymers, silicone oils, metal salts of stearic acid, metal salts of montanic acid, montanic acid ester waxes, polyethylene waxes, and the like, and combinations thereof.

Examples of the weatherproofing agents may include without limitation benzophenone weather proofing agents, amine weather proofing agents, and the like, and combinations thereof.

Examples of the coloring agent may include without limitation dyes, pigments, and the like, and combinations thereof.

Examples of the UV blocking agents may include without limitation titanium oxide (TiO₂), carbon black, and the like, and combinations thereof. The carbon black may be a conductive carbon black, such as graphitized carbon, furnace black, acetylene black, ketchen black, and the like, and combinations thereof, without being limited thereto.

Examples of the fillers may include without limitation glass fiber, carbon fiber, silica, mica, alumina, clay, calcium carbonate, calcium sulfate, glass beads, and the like, and combinations thereof.

Examples of the nucleating agents may include talc, clay, and the like, and combinations thereof.

The additives may be properly added so long as properties of the polycarbonate resin composition are not deteriorated. In one embodiment, the additives may be present in an amount of about 40 wt % or less, for example about 0.1 to about 30 wt %, based on the total weight of the polycarbonate resin composition.

The polycarbonate resin composition may have a UL94 flammability rating of about V0 or more, measured on an about 1 mm-thick specimen, and an impact strength of about 35 kgfcm/cm or more, e.g., about 36 to about 90 kgfcm/cm, measured on a ⅛″-thick specimen by ASTM D1925.

The polycarbonate resin composition may be prepared by any known method of preparing a resin composition. For example, the above components and other additives can be mixed, subjected to melt extrusion in an extruder, and formed into pellets.

Another aspect of the present invention provides a molded article using the polycarbonate resin composition. That is, the polycarbonate resin composition may be formed into molded articles via various processes, such as injection molding, blow molding, extrusion molding, and heat molding. In particular, the composition is useful for molded articles produced via molding and mold-releasing, e.g., electric and electronic components and automobile components.

Hereinafter, the constitution and functions of the present invention will be explained in more detail with reference to the following examples. These examples are provided for illustrative purposes only and are not to be in any way construed as limiting the present invention.

### EXAMPLES

Details of components used in Examples and Comparative Examples are described as follows.

(A) Polycarbonate resin: Polycarbonate having MI of 20 g/10 min (300° C., 1.2 kgf, ISO 1133), produced by Cheil Industries Inc.

(B) Polycarbonate-polysiloxane copolymer: Tarflon having MI of 27 g/10 min (300° C., 1.2 kgf, ISO 1133), produced by Idemitsu Chemicals.

(C1) Siloxane copolyester: TEGOMER H-Si6440P, produced by Evonik Industries.

(C2) Polymethylphenylsiloxane: TSF 437 (RI: 1.499, Viscosity (25° C.): 22 mm²/S), produced by GE Toshiba.

(C3) Polydimethylsiloxane: L-45 (RI: 1.403, Viscosity: 95 cp), NIPPON UNICAR.

(C4) Pentaerythrityl tetrastearate: Loxiol P861, produced by Cognis Oleo Chemicals.

(D) Impact reinforcing agent

(D1) Impact reinforcing agent including core of 310 nm polybutadiene and shell of styrene/acrylonitrile (SM/AN)=71/29, produced by Cheil Industries Inc.

(D2) Impact reinforcing agent including core of 100 nm polybutadiene and shell of methyl methacrylate/styrene (MMA/SM), produced by R&H.

### Examples 1 to 4 and Comparative Examples 1 to 6

The above components are mixed according to compositions listed in Table 1, and 0.3 parts by weight of styrene-acrylonitrile (SAN)-capsulated polytetrafluoroethylene (PTFE), 0.3 parts by weight of an antioxidant (Irganox 1076), and 0.2 parts by weight of a lubricant (Luwax E) are added to 100 parts by weight of the resin composition mixture. The mixture is extruded at 240° C. using a 45φ biaxial extruding machine while side feeding 11 parts by weight of bisphenol-A bis(diphenyl phosphate) (BDP), and the extruded product is formed into pellets. The pellets are dried at 80° C. for 4 hours and then prepared into a specimen using a 6 oz injection molder for property evaluation. Physical properties of the specimen are evaluated as follows, and the results are set forth in Table 1.

Evaluation of Physical Properties

(1) Spiral Flow

Each resin is injected into a spiral mold having a thickness of 2 mm and a width of 12.4 mm, followed by measurement of filled distance from the center of the spiral. The cylinder temperature is 270° C. and the unit is cm.

(2) Flammability Rating

Flammability is measured using a 1 mm specimen based upon the UL94 standard.

(3) Notched-IZOD Impact Strength

Notched-IZOD impact strength is measured using a specimen having a thickness of ⅛″ based upon ASTM D256 (unit: kg·cm/cm).

(4) Mold Release Properties

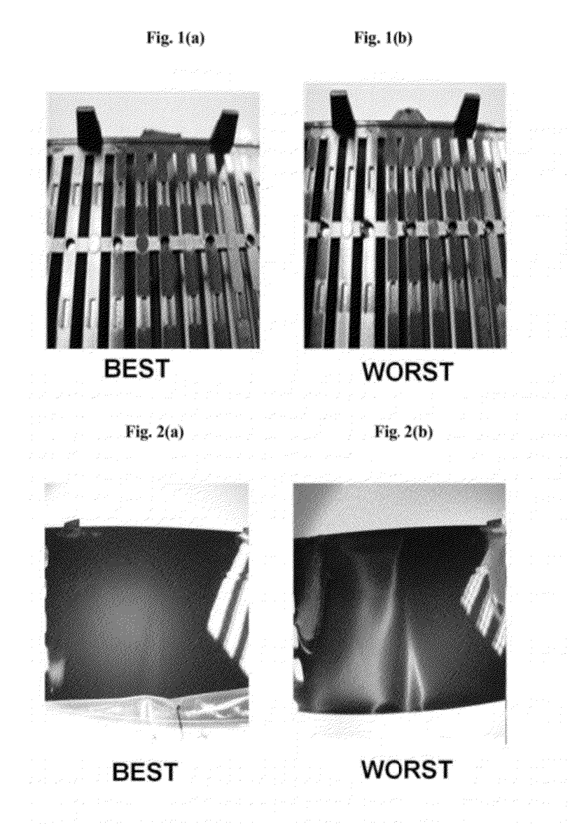

When a grille mold is used, a change in the interval of a grille and an extent to which eject pin marks are changed are evaluated with the naked eye. The best mold release properties and the worst release properties are illustrated in FIG. 1.

5: Best, 4: Good, 3: Moderate, 2: Bad, 1: Worse, 0: Worst

(5) Appearance

An extent to which pearl marks occurred in a welded part are evaluated with the naked eye. The best appearance and the worst appearance are illustrated in FIG. 1.

5: Best, 4: Good, 3: Moderate, 2: Bad, 1: Worse, 0: Worst

TABLE 1

| | Example | | | | Comparative Example | | | | | |
|---|---|---|---|---|---|---|---|---|---|---|
| | 1 | 2 | 3 | 4 | 1 | 2 | 3 | 4 | 5 | 6 |
| (A) | 74 | 72 | 70 | 42 | 68 | 74 | 42 | 74 | 42 | 94 |
| (B) | 20 | 20 | 20 | 50 | 20 | 20 | 50 | 20 | 50 | 0 |
| (C1) | 1 | 3 | 5 | 3 | 7 | — | — | — | — | 1 |
| (C2) | — | — | — | — | — | 1 | 3 | — | — | — |
| (C3) | — | — | — | — | — | — | — | 1 | — | — |
| (C4) | — | — | — | — | — | — | — | — | 3 | — |
| (D1) | 2 | 2 | 2 | 2 | 2 | 2 | 2 | 2 | 2 | 2 |
| (D2) | 3 | 3 | 3 | 3 | 3 | 3 | 3 | 3 | 3 | 3 |
| Spiral flow | 35 | 37 | 40 | 38 | 43 | 36 | 40 | 38 | 41 | 34 |
| Flammability | V-0 | V-0 | V-0 | V-0 | V-1 | V-0 | V-1 | V-0 | V-2 | V-0 |
| rating | | | | | | | | | | |
| IZ(⅛″) | 37 | 35 | 35 | 38 | 25 | 31 | 20 | 34 | 20 | 37 |
| Mold release | 4.0 | 5.0 | 5.0 | 5.0 | 5.0 | 2.0 | 5.0 | 5.0 | 5.0 | 3.0 |
| properties | | | | | | | | | | |
| Appearance | 5.0 | 5.0 | 4.0 | 5.0 | 4.0 | 5.0 | 4.0 | 2.0 | 5.0 | 4.0 |

As shown in Table 1, the resin composition of Comparative Example 1, which includes excessive siloxane copolyester in an amount outside of the range of the present invention, exhibits decreased flame retardancy and IZOD properties. The resin compositions of Comparative Examples 2 and 3, which include polymethylphenylsiloxane instead of siloxane copolyester, have appearance limitations. The resin composition of Comparative Example 4, which includes PDMS, also exhibits remarkably deteriorated appearance. The resin composition of Comparative Example 5, which includes an organic release agent exhibits excellent mold release properties but remarkably reduced flame retardancy and impact resistance. The resin composition of Comparative Example 6, which does not include polycarbonate-polysiloxane copolymer, exhibits deteriorated fluidity, mold release properties, and appearance. That is, when a certain amount of Si—PC is used, effects of siloxane copolyester are optimized, which means that interaction between Si—PC and the siloxane copolyester play an important role in expression of physical properties.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A polycarbonate resin composition that can have excellent mold release properties and appearance, comprising:
a polycarbonate resin (A);
a polycarbonate-polysiloxane copolymer (B); and
a siloxane copolyester (C),
wherein the siloxane copolyester (C) is present in an amount of about 0.1 to about 6% by weight, based on 100 wt % of a base resin including the polycarbonate resin (A), polycarbonate-polysiloxane copolymer (B), and siloxane copolyester (C).

2. The polycarbonate resin composition of claim 1, wherein said siloxane copolyester (C) has a number average molecular weight of about 5,500 to about 7,500 g/mol, and wherein the polyester of the siloxane copolyester has a number average molecular weight of about 1,000 to about 3,000 g/mol.

3. The polycarbonate resin composition of claim 1, wherein said siloxane copolyester (C) is an ABA type block copolymer of a polyester block and a polysiloxane block.

4. The polycarbonate resin composition of claim 1, wherein said siloxane copolyester (C) comprises about 30 to about 70 wt % of a polyester block and about 30 to about 70 wt % of a polysiloxane block.

5. The polycarbonate resin composition of claim 1, wherein said siloxane copolyester (C) comprises a repeat unit represented by Formula 1: 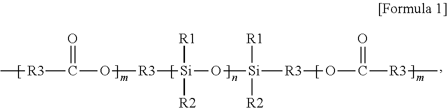
wherein:
R1 and R2 are the same or different and are independently hydrogen, substituted or unsubstituted C1 to C20 alkyl, substituted or unsubstituted C2 to C20 alkenyl, a substituted or unsubstituted C2 to C20 alkynyl, substituted or unsubstituted C1 to C20 alkoxy, substituted or unsubstituted C3 to C30 cycloalkyl, substituted or unsubstituted C3 to C30 cycloalkenyl, substituted or unsubstituted C3 to C30 cycloalkynyl, substituted or unsubstituted C6 to C30 aryl, substituted or unsubstituted C6 to C30 aryloxy, or NRR′, to wherein R and R′ are the same or different and are independently hydrogen or substituted or unsubstituted C1 to C20 alkyl;
R3 is C1 to C10 alkylene or C6 to C20 arylene;
n is an integer from 5 to 50; and
m is an integer from 5 to 30.

6. The polycarbonate resin composition of claim 1, wherein said composition comprises about 40 to about 85 wt % of the polycarbonate resin (A), about 10 to about 55 wt % of the polycarbonate-polysiloxane copolymer (B), and about 0.1 to about 6 wt % of the siloxane copolyester (C), based on 100 wt % of a base resin including the polycarbonate resin (A), polycarbonate-polysiloxane copolymer (B), and siloxane copolyester (C).

7. The polycarbonate resin composition of claim 1, wherein said composition further comprises an impact reinforcing agent.

8. The polycarbonate resin composition of claim 1, wherein said composition further comprises a flame retardant.

9. The polycarbonate resin composition of claim 1, wherein said polycarbonate-polysiloxane copolymer (B) comprises about 1 to about 99 wt % of a polycarbonate block and about 1 to about 99 wt % of a polysiloxane block.

10. The polycarbonate resin composition of claim 1, wherein said resin composition further comprises at least one additive selected from the group consisting of impact reinforcing agents, flame retardants, anti-dripping agents, antimicrobial agents, heat stabilizers, antioxidants, release agents, photo-stabilizers, inorganic additives, surfactants, coupling agents, plasticizers, admixtures, stabilizers, lubricants, anti-static agents, toning agents, a fireproofing agents, weatherproofing agents, coloring agents, UV absorbents, UV blocking agents, tillers, nucleating agents, adhesion aids, adhesives, and combinations thereof.

11. A molded article comprising the polycarbonate resin composition of claim 1.
